(19) United States
(12) Patent Application Publication
(10) Pub. No.: US 2026/0200126 A1
(43) Pub. Date: Jul. 16, 2026

(54) Process for Manufacturing an OSB Wood-Based Panel

(71) Applicant: SWISS KRONO Tec AG, Luzern (CH)

(72) Inventors: Norbert Kalwa, Horn-Bad Meinberg (DE); Maik Hirschberg, Benndorf (DE)

(21) Appl. No.: 18/866,133

(22) PCT Filed: May 9, 2023
(86) PCT No.: PCT/EP2023/062272

§ 371 Date: Nov. 15, 2024

(30) Foreign Application Priority Data
May 18, 2022 (EP) 22174000.4

(51) Int. Cl. B27N 1/02; B27N 3/00; B27N 3/04; C08K 5/544

(52) U.S. Cl. CPC B27N 1/0209; B27N 3/002; B27N 3/04; C08K 5/544

(57) ABSTRACT

A process of manufacturing an OSB wood-based panel includes: Providing wood strands; Gluing the wood strands with a binder system including component A including at least one sugar, at least one sugar alcohol or a mixture thereof, and at least one compound of the general formula (I) Rₐ¹SiX₍₄₋ₐ₎
whereby X is alkoxy,
R¹ is an organic moiety selected from a group including C1-C10 alkyl, which may be interrupted by —O— or —NH—, wherein R¹ includes at least one functional group Q₁ selected from a group including a methacrylic, methacryloxy, vinyl, alkoxy, amino, isocyano and/or epoxy group, and a=0, 1, 2, 3, and a component B consisting of at least one isocyanate, spreading the glued wood strands onto a conveyor belt; and pressing the glued wood strands into an OSB wood-based panel.

### CROSS-REFERENCE TO RELATED APPLICATIONS

This application is the United States national phase of International Patent Application No. PCT/EP2023/062272 filed on May 9, 2023, and claims priority to European Patent Application No. 22 174 000.4, filed on May 18, 2022, the disclosures of each of which are hereby incorporated by reference in their entireties.

### BACKGROUND

### Technical Field

The present disclosure relates to a method of manufacturing an OSB wood-based panel.

### Technical Considerations

Oriented strand boards (OSB) are wood-based panels made from long strands. Originally a waste product from the veneer and plywood industry, OSB is increasingly being used in timber and prefabricated house construction, as OSB is lightweight and still meets the structural requirements placed on building boards. OSBs are used as building boards and as wall or roof cladding or even for flooring.

OSB is manufactured in a multi-stage process, whereby the chips or strands of debarked round wood, preferably softwood, are first peeled off lengthwise using rotating knives. In the subsequent drying process, the natural moisture of the strands is reduced at high temperatures. The moisture content of the strands can vary depending on the adhesive used, although the moisture content should be well below 10% in order to avoid splitting during subsequent pressing. Depending on the adhesive, wetting on moist strands or dry strands may be more favorable. In addition, as little moisture as possible should be present in the strands during the pressing process in order to reduce the vapor pressure generated during the pressing process as much as possible, as this could otherwise cause the raw panel to burst.

After the strands have dried, they are fed into a gluing device in which the glue or adhesive is finely distributed onto the chips. PMDI (polymeric diphenylmethane diisocyanate) or MUPF (melamine-urea-phenol-formaldehyde) glues are predominantly used for gluing. The glues can also be mixed in the OSB. These glues are used because, as mentioned above, OSBs are often used for structural applications. Glues that are resistant to moisture or wetness must be used there.

After gluing, the glued strands are spread alternately lengthwise and crosswise to the production direction in spreading devices so that the strands are arranged crosswise in at least three layers (lower top layer-middle layer-upper top layer). The spreading direction of the lower and upper surface layer is the same, but differs from the spreading direction of the middle layer. The strands used in the top layer and middle layer also differ from each other. For example, the strands used in the top layers are flat and the strands used in the middle layer are less flat or even chip-shaped. Usually, two strands of material are used in the production of OSB: one with flat strands for the subsequent surface layers and one with “chips” for the middle layer. Accordingly, the strands in the middle layer can be of poorer quality, as the bending strength is essentially generated by the surface layers. For this reason, fines produced during machining can also be used in the middle layer of OSB boards.

After the strands have been scattered, they are continuously pressed under high pressure and at high temperatures of 200 to 250° C., for example.

In the production of wood-based panels (HWS), such as the OSB described above, a not inconsiderable proportion of the product costs is caused by the depreciation of the extremely expensive production facilities. The conti presses, which are mostly used today, contribute a considerable proportion to the total cost of the product. The limiting factor for wood-based materials is always the curing of the glues used. In all cases, these are cured by thermal activation. However, as wood is a thermal insulator, heat transfer from the press to the chip or fiber cakes plays an important role.

It is known that the addition of hardeners can accelerate the curing of the glues and thus increase the output of the system. This is a tried and tested procedure for the urea-formaldehyde glues used in large quantities, as the hardeners have little or no tendency to harden the glue at room temperature. This means that little or no pre-curing takes place during short system downtimes.

The situation is different with PMDI glue. This glue, which is used in particular in the production of OSB, already reacts with most hardeners (e.g., amines, polyols) at room temperature.

These hardeners often also have the problem that they have to be added to the PMDI, including thorough mixing, before being applied to the strands. These hardeners are usually used as aqueous solutions, which leads to an additional reaction of the PMDI with the water to form polyurethane and to the deposition of the polyurethane. This results in disadvantages, in particular a reduced possibility of influencing the output and productivity of the production plant, and higher costs.

A chemical that is not a classic hardener but would nevertheless accelerate the hardening of PMDI glue could potentially significantly increase production volumes.

### SUMMARY

The present disclosure is based on the technical object of increasing the productivity of an OSB plant. If possible, no technical changes should have to be made. The process should also not become significantly more expensive.

This object is solved with a process for the production of OSB with features as described herein.

Accordingly, a method of manufacturing an OSB wood-based panel is provided, comprising the following steps:
a) Providing wood strands;
b) Gluing the wood strands with a binder system comprising
   a component A comprising
      i) at least one sugar, at least one sugar alcohol or a mixture thereof, and
      ii) at least one compound of the general formula (I)

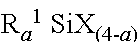

whereby
   X is alkoxy,
   R¹ is an organic moiety selected from a group comprising C1-C10 alkyl, which may be interrupted by —O— or —NH—
   wherein R¹ comprises at least one functional group Q₁ selected from a group comprising a methacrylic, methacryloxy, vinyl, alkoxy, amino, isocyano and/or epoxy group, and
   a=0, 1, 2, 3, in particular 0, 1 or 2, and
a component B consisting of at least one isocyanate,
where component A and component B are applied separately to the wooden strands,
c) Spreading the glued wood strands onto a conveyor belt; and
d) Pressing the glued wood strands into an OSB wood-based panel, and
wherein the process is carried out in a production plant with an increase in plant speed of at least 10%, preferably of at least 15%, more preferably of at least 20%, even more preferably of at least 25% compared to an initial speed of the production plant.

In the context of the present disclosure, an increase in plant speed is to be understood as an acceleration of the plant speed compared to an initial speed of the production plant. Typically, production lines for OSB production are operated at a speed of up to 340 mm/sec. As can be seen in the embodiment examples given below, the present method now allows the process or feed speed to be increased to more than 340 mm/sec, preferably more than 380 mm/sec, or preferably ≥400 mm/sec. The feed rate can therefore be 400-460 mm/sec, preferably 400-435 mm/sec. It should be noted that the absolute feed rate depends on the length of the production line and the thickness of the OSB to be produced; i.e., the absolute feed rate can vary from production line to production line.

The use of sugar-containing binder compositions in wood-based panels is known. For example, EP 3 067 402 A1 describes a binder composition for wood-based panels which can be produced from a sugar (for example sorbitol), a modified silane (tetraethoxysilane, glycidyloxypropyltriethoxysilane) and an isocyanate (PMDI). The binder composition is sprayed onto wood strands as a mixture of these substances and the wood strands provided with the binder composition are then pressed into OSB. The use of a mixture of the three substances prevents absorption or diffusion of the PMDI glue into the wood fibers, which makes it possible to reduce the amount of binder required in the manufacturing process for wood-based panels. This effect results from the fact that the compounds formed from the silane compound and polyalcohol can react with the polymer adhesive, such as PMDI glue, or also with the OH groups of the wood. The macromolecules formed by condensation with the glue are now no longer able to pass through the hydrophobic fatty acid layer of the strands due to the hydrophilic residues. As a result, the binder composition remains on the surface of the strands or fibers and does not diffuse into the wood matrix. It can also be said that the polymer adhesive is now equipped with a hydrophilic anchor. According to EP 3 067 402 A1, the use of a mixture of the 3 components sugar, silane and isocyanate before applying the binder to the wood strands is therefore absolutely necessary in order to achieve a reduction in the amount of binder used.

EP 3 995 538 A1 describes a sugar-containing binder system for wood-based panels, which consists of 3 components: a sugar, polyvinyl alcohols and isocyanate. The 3 components are applied separately and successively to the wood particles used for the wood-based panels and the wood particles coated in this way are then pressed to form wood-based panels.

The main difference between the present method and the methods described in the prior art is the separate application of components A (sugar and silane) and component B (isocyanate). According to the present disclosure, a 2-component system comprising component A consisting of sugar/sugar alcohol and at least one silane and component B consisting of an isocyanate is added separately to the strands during gluing in a mixer (e.g., trough mixer) or in a gluing drum (coil). This means that there is no mixing of the components of the binder system before application to the wood strands, so that no undesirable reaction can take place, e.g., of the isocyanate with water from an aqueous solution of component A. The risk of pre-curing of the binder is thus reduced.

Furthermore, it has been shown that the use of the 2-component system of sugar-silane reaction product and isocyanate according to the present disclosure surprisingly accelerates the production speed. This effect cannot be readily explained.

As already mentioned above and as can be seen from the non-limiting embodiment examples given below, the present method now allows the process or feed speed to be increased to more than 340 mm/sec, preferably more than 380 mm/sec, or preferably ≥400 mm/sec. Thus, the feed rate can be 400-460 mm/sec, preferably 400-435 mm/sec.

Using the method according to the present disclosure, more OSB can therefore be produced. Usually, an increase in the amount of OSB produced is achieved by increasing the amount of glue. It is therefore all the more surprising that the proven increased output is accompanied by a reduction in the amount of glue. The increased quantity of OSB produced also results in a cost advantage in terms of the specific costs of the production plant per cubic meter of OSB produced.

As mentioned, the glue quantity is also reduced in the process according to the present disclosure, which leads to further cost reductions. With a reduction of around 10%, an amount of several thousand euros can be achieved at current costs for PMDI adhesive to a production yield of up to 2,000 cubic meters per day. This also makes it possible to improve the ecological footprint of the OSB produced by reducing the use of fossil raw materials used in the production of PMDI. A saving of 10% corresponds to around 2 kg per cubic meter of OSB at 1,500 cubic meters of OSB per day adds up to 3,000 kg per day and at 2,000 euros per tonne for PMDI, this already results in a saving of around 6 thousand euros per day.

The silane used in component A is actually a primer designed to improve the adhesion of the isocyanate to the strands. Surprisingly, this primer also allows an acceleration of the production speed, which is not easy to explain, as the substance class of silanes is not known for this property. The 2-component binder system is applied either before, with or after the isocyanate application.

The separate application of the components of the binder system also makes it possible to quickly change the proportions of the components of the binder system. A further advantage is that ecologically harmful ingredients such as heavy metals and halogens can be dispensed with in the binder system.

In some non-limiting embodiments, the present method comprises the following steps:
a) Producing wood strands (OSB strands) from suitable wood,
b) Temporary storage of the wood strands, especially in silos or bunkers,
c) Drying the wood strands,
d) Sorting or sifting the wood strands according to the size of the wood strands,
e) Gluing the wood strands with the above-mentioned binder system comprising a component A and a component B,
f) applying the glued wood strands to a conveyor belt by means of wind and/or throw sifting, and
g) Pressing the glued wood strands arranged on the conveyor belt.

In addition to the process steps listed above, the wood chips are cleaned of foreign matter before they are shredded, e.g., as part of a dry cleaning or wet cleaning process.

### Sugar of Component A

In some non-limiting embodiments of component A of the present binder system, reducing mono- and/or disaccharides are used. For the purposes of the present disclosure, reducing mono- or disaccharides are saccharides which have at least one aldehyde group in the linear state. Non-reducing saccharides, on the other hand, have no free aldehyde groups. An example of a non-reducing disaccharide is sucrose, in which the two monosaccharides glucose and fructose are linked to each other under neutral and basic conditions via an α,β-1,2-glycosidic bond in acetal form. However, under acidic conditions, sucrose can be split into the reducing monosaccharides glucose and fructose.

In some non-limiting embodiments, pentoses and hexoses are used as monosaccharides. Pentoses and hexoses are selected from the group comprising arabinose, ribose, xylose, glucose (dextrose), mannose, galactose and/or fructose. The saccharides mentioned can be used both in their D-form and in their L-form.

In some non-limiting embodiments, the sugar alcohols used are selected from a group comprising tetravalent, pentavalent and/or hexavalent alcohols (also known as reduced sugars or alditols). The tetravalent alcohols threitol, erythritol, and/or pentaerythritol, the pentavalent alcohols arabitol, adonitol, and/or xylitol, and/or the hexavalent alcohols sorbitol, mannitol, dulcitol, and/or dipentaerythritol can be used. The use of sorbitol (or sorbitol) has proven to be advantageous.

Accordingly, only sugar-based polyhydric alcohols are used as polyols or polyalcoholic compounds. The use of synthetic polyols such as glycols, such as ethylene glycol, propylene glycol, diethylene glycol, triethylene glycol, polyethylene glycol, polypropylene glycol and/or polybutylene glycol is therefore avoided. In some embodiments, no 1,2-propylene glycol is used as a glue component in the present case.

### Silane of Component A

The hydrolyzable moiety X of the silane of formula (I) is advantageously selected from a group comprising C₁₋₆-alkoxy, for example methoxy, ethoxy, n-propoxy, i-propoxy and/or butoxy.

The organic moiety R¹ of the silane of the general formula (I) is preferably selected from a group comprising C1-C₁₀ alkyl, preferably C1-C8 alkyl, which may be interrupted by —O— or —NH—, such as for example methyl, ethyl, propyl, pentyl, hexyl, heptyl, and/or octyl.

In some non-limiting embodiments, the at least one functional group Q¹ of the silane of the general formula (I) is selected from a group comprising an epoxide group, for example a glycidyl or glycidyloxy group, a methacryloxy, a vinyl or an isocyano group. A preferred functional group Q¹ is a glycidyloxy group or isocyano group. The functional group Q¹ advantageously has a residue with a double bond or an epoxide group which can be activated and polymerized by means of UV radiation.

The functional groups, via which crosslinking with the polymer adhesive and the wood surface is possible, comprise polymerizable and/or polycondensable groups, whereby the polymerization reaction is also to be understood as polyaddition reactions. The functional groups are preferably selected in such a way that organic crosslinking between the polymer adhesive and the wood surface and also, if necessary, between different adhesive systems can be carried out via polymerization and/or condensation reactions that may be catalyzed.

In some non-limiting embodiments, the present binder composition comprises at least two compounds of the general formula (I).

Thus, in some non-limiting embodiments, a silane mixture can be used in which a first compound corresponds to the formula SiX₄ with X being alkoxy, for example methoxy, ethoxy, n-propoxy or i-propoxy, and a second compound corresponds to the formula RₐSiX₍₄₋ₐ₎ with a=1 or 2, wherein X is alkoxy, for example methoxy, ethoxy, n-propoxy or i-propoxy, R is methyl, ethyl, n-propyl or n-butyl and Q is a glycidyl or glycidyloxy group, an alkoxy, an amino or an isocyano group.

In some non-limiting embodiments, a silane mixture can be used in which a first compound corresponds to the formula SiX₄ where X is methoxy, ethoxy, n-propoxy or i-propoxy, and a second compound corresponds to the formula RₐSiX₍₄₋ₐ₎ where a=1, where X is methoxy, ethoxy, n-propoxy or i-propoxy, R is methyl, ethyl, n-propyl or n-butyl and Q is glycidyl or glycidyloxy group.

The molar ratio of first and second compound can be 0.1 to 1 mol, preferably 0.1 to 0.5 mol, or preferably 0.1 to 0.4 mol.

In some non-limiting embodiments, the silanes used are tetraethoxysilane, tetramethoxysilane, gamma-isocyanatopropyltriethoxysilane, glycidyloxypropyltriethoxysilane, and/or glycidyoxypropyltrimethyoxysilane.

According to some non-limiting embodiments, component A comprises a silane mixture in which a first compound corresponds to the formula SiX₄ with X being alkoxy, for example methoxy, ethoxy, n-propoxy or i-propoxy, and a second compound corresponds to the formula RₐSiX₍₄₋ₐ₎ with a=1 or 2, where X is alkoxy, for example methoxy, ethoxy, n-propoxy or i-propoxy, R is methyl, ethyl, n-propyl or n-butyl and Q is a glycidyl or glycidyloxy group, an alkoxy, an amino or an isocyano group, and tetravalent alcohols such as threitol, erythritol, and/or pentaerythritol, pentavalent alcohols such as arabitol, adonitol, and/or xylitol, and hexavalent alcohols such as sorbitol, mannitol, dulcitol, and/or dipentaerythritol.

According to some non-limiting embodiments, component A comprises a silane mixture in which a first compound corresponds to the formula SiX₄ where X is methoxy, ethoxy, n-propoxy or i-propoxy, and a second compound corresponds to the formula RₐSiX₍₄₋ₐ₎ where a=1, wherein X is methoxy, ethoxy, n-propoxy or i-propoxy, R is methyl, ethyl, n-propyl or n-butyl and Q is a glycidyl or glycidyloxy group, and hexavalent alcohols such as sorbitol, mannitol, dulcitol, and/or dipentaerythritol.

According to some non-limiting embodiments, component A comprises tetraethoxysilane, glycidyloxypropyltriethoxysilane, and/or sorbitol.

In some non-limiting embodiments, it is possible to add nanoparticles to the component A composition. The particles preferably used have a size of 2 to 400 nm, preferably 2 to 100 nm, or preferably 2 to 50 nm. The particles can be of oxidic, hydroxidic or oxihydroxidic nature, which can be produced by different processes such as ion exchange process, plasma process, sol-gel process, grinding or also flame deposition. In some non-limiting embodiments, particles based on SiO₂, Al₂O₃, ZrO₂, TiO₂, SnO are used, whereby nanoscale SiO₂ particles in the form of an aqueous suspension (e.g. acidic suspension of SiO₂ stabilized with Al³⁺- or Na⁺-cations) can be used.

The at least one component A consisting of silane and sugar/sugar alcohol is applied to the wood strands in a variant in an amount of 0.01 to 0.5 wt %, preferably 0.02 to 0.4 wt %, or preferably 0.04 to 0.3 wt % relative to wood atro, for example to the wood strands. Wood atro is the unit of measurement for the mass of one ton of absolutely dry wood.

The amount of component A of at least one silane compound of the formula (I) and of the at least one sugar/sugar alcohol can be 0.4 to 20 wt %, preferably 0.8 to 16 wt %, or preferably 1.6 to 12 wt % relative to the amount of isocyanate as component B.

Preferably, the at least one component A of silane and sugar/sugar alcohol is used as an aqueous solution with a concentration of 10-50 wt %, preferably 12-30 wt %, and corresponding amounts of the aqueous solution are used to achieve the corresponding final concentration of component A on the wood strands and in relation to the isocyanate.

The component A of the binder composition disclosed herein can be prepared in a process comprising the following steps:
providing at least one, preferably at least two different compounds of the general formulae (I);
addition of at least one sugar or sugar alcohol;
addition of at least one catalyst, for example an acid, to the mixture of at least one compound of formula (I) and at least one sugar/sugar alcohol; and
precipitation and separation of the reaction mixture of at least one compound of formula (I) and at least one sugar/sugar alcohol.

Suitable inorganic and/or organic acids as catalysts are selected from a group comprising phosphoric acid, acetic acid, p-toluenesulfonic acid, hydrochloric acid, formic acid and/or sulfuric acid. Also suitable are ammonium salts such as ammonium sulphate, which react as weak acids. p-Toluenesulphonic acid is preferred.

The use of sodium glycerophosphate is suitable for precipitating the reaction mixture of at least one compound of formula (I) and at least one sugar/sugar alcohol. Other suitable precipitating agents are alkaline solutions such as NaOH, KOH and/or ammonium hydroxide solutions.

### Isocyanate as Component B

In some non-limiting embodiments, the at least one isocyanate is based on aromatic polyisocyanates, for example polydiphenylmethane diisocyanate (PMDI), toluene diisocyanate (TDI) and/or diphenylmethane diisocyanate (MDI), PMDI being preferred.

In some non-limiting embodiments, the at least one isocyanate is used in an amount of 2 to 5 wt %, preferably 2.2 to 4 wt %, or preferably 2.5 to 3 wt % relative to wood atro, for example sprayed onto the wood strands and/or wood chips.

In some non-limiting embodiments, the present aqueous binder system preferably has no components other than the sugar, sugar alcohol and isocycanate. It is therefore free of formaldehyde, synthetic polyols and/or plastics and thickeners, for example polyvinyl alcohol or polyvinyl acetate, or acrylates.

According to the present disclosure, the binder components are sprayed onto the wood strands as separate components. Component A can be applied before, with or after the application of the isocyanate as component B.

As mentioned above, component A is applied to the wood strands in the form of an aqueous solution. If the isocyanate used as component B were now to come into contact with the aqueous solution of component A, the isocyanate would easily react with water to form polyurethane, with the polyurethane formed being deposited in the mixer and clogging the lines or spray heads of the mixer. To avoid this, it is therefore advantageous to provide the binder components separately from each other according to the present disclosure and to spray them onto the wood strands separately from each other.

### Mixer/Coil

The binder components can be applied in a glue drum (coil) or a trough mixer.

A gluing device in the form of a coil used for the present process consists of a cylinder and at least one supply bar for the supply of adhesive and compressed air with spray discs, for the drive of which pneumatic drive motors arranged in housings are provided. Such a gluing device is described in DE 10 2008 046 637 A1.

A suitable trough mixer is sold by Dieffenbacher, for example. Such glue mixers ensure uniform glue distribution thanks to their large chamber volume and the optimum dwell time of the material. To ensure an optimum gluing result, the constant filling level of the mixer is maintained by an outlet flap.

After the binder components have been applied to the wood strands, the glued wood strands are placed on a conveyor belt or spread and then pressed into an OSB wood-based panel.

Pressing can take place at a pressing temperature of 150 to 250° C., preferably 180° C. to 220° C., and a pressing time of 30 to 240 seconds, preferably 100 to 210 seconds, or 150 to 180 seconds.

### OSB Board

According to the present disclosure, the present method is used to produce oriented strand boards (OSB).

The OSBs produced by the methods disclosed herein thus have a binder composition comprising
at least one component A of at least one silane of the formula (I) and at least one sugar, at least one sugar alcohol, or a mixture;
at least one component B comprising at least one isocyanate.

As mentioned above, oriented strand boards (OSB) are manufactured from long strands in a multi-stage process.

In a first step, strands of debarked roundwood, preferably softwood, are peeled off lengthwise using rotating knives.

The wooden strands produced in this way can have a length of 50 to 200 mm, preferably 70 to 180 mm, more preferably 90 to 150 mm; a width of 5 to 50 mm, preferably 10 to 30 mm, more preferably 15 to 20 mm; and a thickness of 0.1 to 2 mm, preferably 0.3 to 1.5 mm, more preferably 0.4 to 1 mm.

In some non-limiting embodiments, for example, the wood strands have a length of 150 to 200 mm, a width of 15 to 20 mm, a thickness of 0.5 to 1 mm and a maximum moisture content of 50%.

As described above, OSB typically consists of two surface layers confining a middle layer, whereby the surface layers and middle layer can consist of different types of wood strands. This means that flat strands can be used in the surface layers, while lower quality strands (or even chips) can be used in the middle layer.

It is also possible to use different types of binder systems in the surface layers and in the middle layer.

In some non-limiting embodiments, the wood strands for the top layer(s) and middle layer of the OSB can each be provided with the binder system consisting of component A and component B.

According to some non-limiting embodiments, it is also possible that only the wood strands for the middle layer of the OSB are provided with the binder system consisting of component A and component B, and the wood strands for the top layer(s) are only provided with isocyanate as a binder.

In both embodiments just described, the amount of isocyanate used in the top layer is slightly increased compared to the amount of isocyanate used in the middle layer.

The isocyanate is applied to wood strands for the top layers in an amount of 2.5 to 3.5 wt %, preferably 2.7 to 3.2 wt %, or preferably 2.9 to 3.0 wt % based on wood atro.

On the other hand, the amount of isocyanate applied to wood strands for the middle layer is 2 to 3 wt %, preferably 2.2 to 2.8 wt %, or preferably 2.4 to 2.6 wt % based on wood atro.

The coarse particle boards (OSB) produced using the method described have a transverse tensile strength of greater than 0.3 N/mm², preferably greater than 0.4 N/mm², preferably greater than 0.45 N/mm², or preferably greater than 0.5 N/mm². The transverse tensile strength can be in a range of 0.3 to 0.6 N/mm², preferably 0.4 to 0.6 N/mm², or preferably 0.45 to 0.55 N/mm².

Furthermore, the coarse particle boards (OSB) produced using the process described have moduli of elasticity in the longitudinal direction of 3200 to 4000 MPa, preferably 3400 to 3800 MPa, and moduli of elasticity in the transverse direction of 1400 to 1800 MPa, preferably 1500 to 1600 MPa.

The present OSB wood-based panel can have a bulk density of 300 to 1000 kg/m³, preferably 500 to 800 kg/m³, preferably 600 to 700 kg/m³.

The thickness of the present OSB wood-based panel can be 5 to 50 mm, preferably 8 to 40 mm, with a thickness of 8 to 30 mm being preferred.

The present disclosure is explained in more detail below using several non-limiting examples of embodiments.

### EXAMPLE 1: PREPARATION OF COMPONENT A OF THE BINDER SYSTEM

To a mixture consisting of 20.33 g tetraethyl orthosilicate (0.1 mol) and 139.2 glycidyloxypropyltriethoxysilane (0.5 mol), a mixture of 34.2 g sorbitol (50 wt % in the water) and 4 g para-toluenesulfonic acid is added with stirring. Hydrolysis of the silane mixture and a reaction with the sorbitol take place, whereby the degree of condensation is deliberately kept low. The course of the reaction and the degree of condensation are monitored by means of Si-NMR measurements.

After a stirring time of 4 hours, a mixture of 136.8 g demin. water and 34 g sodium glycerophosphate is added to the above reaction mixture. This mixture is stirred for a further 60 minutes.

After a resting time of approx. 1 hour, a two-phase mixture is formed. The lower, now aqueous phase containing the reaction product of silanes and sorbitol is separated from the upper alcohol phase and used as component A.

### EXAMPLE 2

On an OSB line, the top layer (DS) strands are sprayed with 2.9 wt % PMDI on wood atro in the coil. In the middle layer (MS), 2.5 wt % PMDI is added to wood atro in a trough mixer. In addition, component A is added to the middle layer (MS) in an amount of 1.6 wt % based on PMDI (0.04 wt % on wood atro). Component A was used in a concentration of 12.5%. The delivery concentration was 50 wt %.

Before the addition of component A, a zero sample without silane component A (plate thickness: 18 mm) was first taken at the maximum speed of 340 mm/sec usually specified by the quality parameters. After starting the addition of silane, another sample was taken. The production speed was then increased to 400 or 435 mm/sec. This was the maximum speed that could be produced with the existing chip quantity for the middle layer. This corresponds to an increase in line speed of 27%. Samples were taken at both speeds. Finally, a sample 10 without silane was taken at 435 mm/sec. After cooling, the samples were analyzed for some important technological values.

| | No. | | | | |
|---|---|---|---|---|---|
| Parameters | 1 | 2 | 3 | 4 | 5 |
| Thickness of the OSB | 18 | 18 | 18 | 18 | 18 |
| in mm | | | | | |
| Feed rate in mm/sec | 340 | 340 | 400 | 435 | 435 |
| Press time factor (PZF) | 4.8 | 4.8 | 4.0 | 3.7 | 3.7 |
| in sec/mm | | | | | |
| Gluing PMDI | | | | | |
| MS in % on wood | 2.5 | 2.5 | 2.5 | 2.5 | 2.5 |
| DS in % on wood | 2.9 | 2.9 | 2.9 | 2.9 | 2.9 |
| Dosage of component | | | | | |
| A (silane and sorbitol) | | | | | |
| MS in % on wood | 0 | 0.04 | 0.04 | 0.04 | 0 |
| Density of OSB in kg/m³ | 602 | 606 | 594 | 576 | 580 |
| Transverse tension of | 0.38 | 0.48 | 0.44 | 0.41 | 0.31 |
| the OSB in N/mm² | | | | | |
| E-modulus of the OSB | | | | | |
| in MPa | | | | | |
| Longitudinal | 3540 | 3855 | 3790 | 3490 | 3240 |
| Across | 1560 | 1681 | 1620 | 1490 | 1410 |

As can be seen from the table, the minimum value for the transverse tensile strength of 0.3 N/mm² for OSB 3, as required by the standard DIN EN 300, 09/2006: Boards made of long, flat, oriented strand boards (OSB)-Definitions, classification and requirements, is achieved by all samples. In terms of modulus of elasticity, sample 4 falls slightly short of the required values (3500 and 1400 MPa) and sample 5 falls well short. In all cases, it can be observed that the values with silane are significantly higher than the comparative values without silane. The technological values determined for the sample with silane at the maximum speed are also still at the level of sample 1.

### EXAMPLE 3

On an OSB line, the surface layer (DS) strands are sprayed with 2.9 wt % PMDI on wood atro in the coil. In the middle layer (MS), 2.5 wt % PMDI is added to wood atro in a trough mixer. This OSB was produced as a zero sample. The silane-containing component A was then added to both the top layer (DS) and the middle layer (MS).

In the top layer (DS), 1.6 wt % of component A containing silane was dosed onto PMDI (0.05 wt % onto wood atro). In the middle layer (MS), 2.5 wt % of component A containing silane was dosed onto PMDI (0.06 wt % onto wood atro). The silane was used in a concentration of 12.5%. The delivery concentration was 50 wt %.

Before the addition of silane, the zero sample without silane (panel thickness: 18 mm) was first taken at the maximum speed of 340 mm/sec, which is usually specified by the quality parameters. After the silane addition was started, another sample was taken. The production speed was then increased to 400 or 460 mm/sec. This speed could only be produced for a short time due to the resulting lack of chips for the middle layer. However, the required samples could be drawn. This corresponds to an increase in line speed of 27%. Samples were taken at both speeds. Finally, an attempt was made to pull another sample without silane at 460 mm/sec. However, splitting occurred there. After cooling, the samples were analyzed for some important technological values.

| | No. | | | | |
|---|---|---|---|---|---|
| Parameters | 1 | 2 | 2 | 3 | 4 |
| Thickness in mm | 18 | 18 | 18 | 18 | 18 |
| Feed rate in mm/sec | 340 | 340 | 400 | 460 | 460 |
| Press time factor (PZF) | 4.8 | 4.8 | 4.0 | 3.5 | 3.5 |
| in sec/mm | | | | | |
| Gluing PMDI | | | | | |
| MS in % on wood | 2.5 | 2.5 | 2.5 | 2.5 | 2.5 |
| DS in % on wood | 2.9 | 2.9 | 2.9 | 2.9 | 2.9 |
| Dosage of component | | | | | |
| A (silane and sorbitol) | | | | | |
| MS in % on wood | 0 | 0.06 | 0.06 | 0.06 | 0 |
| DS in % on wood | 0 | 0.05 | 0.05 | 0.05 | 0 |
| Density of OSB in kg/m³ | 608 | 600 | 611 | 599 | — |
| Transverse tension of | 0.38 | 0.53 | 0.47 | 0.41 | — |
| the OSB in N/mm² | | | | | |
| E-modulus of the OSB | | | | | |
| in MPa | | | | | |
| Longitudinal | 3550 | 3931 | 3820 | 3603 | — |
| Across | 1580 | 1699 | 1666 | 1590 | — |

The speed could also be significantly increased in this test. At a feed rate of 460 mm/sec, no more OSB could be produced without the GS 55.

There are one or more advantages
Significant increase in production volumes
Reduction of the risk of pre-hardening
Cost reduction

1. A process of manufacturing an OSB wood-based panel comprising:
a) Providing wood strands;
b) Gluing the wood strands with a binder system comprising
a component A comprising
i) at least one sugar, at least one sugar alcohol or a mixture thereof, and
ii) at least one compound of the general formula (I) 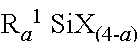
whereby
X is alkoxy,
R¹ is an organic moiety selected from a group comprising C1-C10 alkyl, which may be interrupted by —O— or —NH—
wherein R¹ comprises at least one functional group Q₁ selected from a group comprising a methacrylic, methacryloxy, vinyl, alkoxy, amino, isocyano and/or epoxy group, and
a=0, 1, 2, 3, in particular 0, 1 or 2, and
a component B consisting of at least one isocyanate,
where component A and component B are applied separately to the wooden strands,
c) spreading the glued wood strands onto a conveyor belt; and
d) pressing the glued wood strands into an OSB wood-based panel, and
wherein the process is carried out in a production plant with an increase in plant speed of at least 10% compared to the initial speed of the production plant.

2. The process according to claim 1, wherein the at least one sugar of component A is a monosaccharide from the group of pentoses and hexoses.

3. The process according to claim 1, wherein the at least one sugar alcohol of component A is selected from a group comprising tetravalent, pentavalent, and/or hexavalent alcohols.

4. The process according to claim 1, wherein the moiety X of the silane of formula (I) is selected from a group comprising C₁₋₆-alkoxy.

5. The process according to claim 1, wherein the organic moiety R¹ of the silane of formula (I) is selected from a group comprising C1-C10 alkyl, which may be interrupted by —O— or —NH.

6. The process according to claim 1, wherein the at least one functional group Q¹ of the silane of formula (I) is selected from a group comprising an epoxide group a methacryloxy, or an isocyano group.

7. The process according to claim 1, wherein at least two silane compounds of the formula (I) are used.

8. The process according to claim 1, wherein the at least one component A comprising silane and sugar/sugar alcohol is applied to the wood strands in an amount of 0.01 to 0.5% by weight relative to wood atro.

9. The process according to claim 1, wherein the at least one isocyanate is polydiphenylmethane diisocyanate (PMDI), toluene diisocyanate (TDI) and/or diphenylmethane diisocyanate (MDI).

10. The process according to claim 1, wherein the at least one isocyanate is applied to the wood strands in an amount of 2 to 5% by weight relative to wood atro.

11. The process according to claim 1, wherein the wood strands for the top layer(s) and middle layer of the OSB are each provided with the binder system comprising component A and component B.

12. The process according to claim 1, wherein only the wood strands for the middle layer of the OSB are provided with the binder system comprising component A and component B, and the wood strands for the top layer(s) are provided only with isocyanate as binder.

13. The process according to claim 1, wherein the process is carried out in a production plant with an increase in plant speed of at least 15% compared to the initial speed of the production plant.

14. The process according to claim 1, wherein the process is carried out in a production plant with an increase in plant speed of at least 20% compared to the initial speed of the production plant.

15. The process according to claim 1, wherein the process is carried out in a production plant with an increase in plant speed of at least 25% compared to the initial speed of the production plant.

16. The process according to claim 2, wherein the at least one sugar of component A is selected from the group comprising arabinose, ribose, xylose, glucose (dextrose), mannose, galactose and/or fructose.

17. The process according to claim 5, wherein the organic moiety R¹ of the silane of formula (I) is selected from a group comprising C1-C8 alkyl, which may be interrupted by —O— or —NH—.

18. The process according to claim 6, wherein the epoxide group is a glycidyl or glycidyloxy group.

19. The process according to claim 8, wherein the at least one component A comprising silane and sugar/sugar alcohol is applied to the wood strands in an amount of 0.02 to 0.1% by weight relative to wood atro.

20. The process according to claim 10, wherein the at least one isocyanate is applied to the wood strands in an amount of 2.2 to 4% by weight relative to wood atro.
